(19) United States
(12) Patent Application Publication
(10) Pub. No.: US 2026/0089280 A1
(43) Pub. Date: Mar. 26, 2026

(54) IMAGE FORMING APPARATUS, METHOD OF CONTROLLING IMAGE FORMING APPARATUS, AND STORAGE MEDIUM

(71) Applicant: CANON KABUSHIKI KAISHA, Tokyo (JP)

(72) Inventor: SHINICHI KANEMATSU, Chiba (JP)

(21) Appl. No.: 19/328,917

(22) Filed: Sep. 15, 2025

(30) Foreign Application Priority Data
Sep. 24, 2024 (JP) 2024-165468

(51) Int. Cl. H04N 1/00; H04N 1/047

(52) U.S. Cl. CPC H04N 1/00814; H04N 1/00652; H04N 1/00896; H04N 1/047

(57) ABSTRACT

A method of controlling an image forming apparatus including an image forming unit including an environment sensor that detects environmental information and an image reading unit that reads an image of a document conveyed by a document conveyance unit includes acquiring the environmental information from the environment sensor and controlling conveyance of the document based on the acquired environmental information to enable the image reading unit to perform document conveyance control based on the environmental information irrespective of whether the image forming unit is in a power saving state.

### BACKGROUND

### Field of the Technology

The present disclosure relates to an image forming apparatus, a method of controlling an image forming apparatus, and a storage medium.

### Description of the Related ARt

In a printer, a copier, or a facsimile apparatus, an auto document feeder (ADF)for conveying a document sheet can be provided. When a document sheet is conveyed, the conveyance resistance varies depending on the thickness and size of the document sheet. As a result, the conveyance speed fluctuates, and the length of the image read from the document sheet in the sub-scanning direction may expand or contract.

Japanese Patent Laid-Open No. 2020-188364 describes a technique for setting the driving speed of a driving unit that drives a conveyance unit based on the thickness of a document sheet to be conveyed. The technique described in Japanese Patent Laid-Open No. 2020-188364 is not seen to discuss document conveyance control based on environmental information.

An image forming apparatus typically includes an image forming unit such as a printer engine and an image reading unit that conveys a document using a document conveyance unit and reads an image of a document. In the image forming apparatus, for example, the image forming unit includes an environment sensor for detecting environmental information, such as temperature and humidity to maintain the quality (image quality) of an image formed on a recording medium irrespective of the environment. The image reading unit may not include the above-described environment sensor. In such an image forming apparatus, for example, in a case where the image forming unit is in a mode for a power saving state (power saving mode) and is not energized, it is difficult for the image reading unit to perform document conveyance control based on environmental information.

To ensure the quality of an image read from a document (document sheet), it is desirable to perform document conveyance control in consideration of the influence of changes in the surrounding environment. This is because the conveyance speed of the document may vary due to changes in environmental information, such as temperature and humidity, which, as a result, may affect the quality of the image read from the document (document sheet).

### SUMMARY

The present disclosure is directed to a technique for enabling an image reading unit to perform document conveyance control based on environmental information irrespective of whether an image forming unit that includes an environment sensor for detecting the environmental information is in a power saving state.

According to an aspect of the present disclosure, an image forming apparatus includes an image forming unit including an environment sensor configured to detect environmental information, an image reading unit configured to read an image of a document conveyed by a document conveyance unit, at least one memory storing a program, and at least one processor that when executing the program is caused to acquire the environmental information from the environment sensor and control conveyance of the document based on the acquired environmental information.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a schematic configuration of an image forming apparatus according to a first embodiment.

FIG. 2 illustrates an example of an image reading apparatus according to the first embodiment.

FIG. 3 is a cross-sectional view illustrating an example of an internal configuration of the image reading apparatus according to the first embodiment.

FIG. 4 illustrates examples of a reader and an auto document feeder in a case where the auto document feeder is in an open state relative to the reader in the image reading apparatus according to the first embodiment.

FIG. 5 is a diagram illustrating an example of hardware configuration of the image reading apparatus according to the first embodiment.

FIG. 6 is a diagram illustrating a configuration example of a control system of the image forming apparatus according to the first embodiment.

FIG. 7 is a flowchart illustrating an example of a processing procedure in a method of controlling the image forming apparatus according to the first embodiment.

FIGS. 8A and 8B illustrate processing for correcting a document conveyance speed according to the first embodiment.

FIG. 9 is a flowchart illustrating an example of a processing procedure in a method of controlling an image forming apparatus according to a second embodiment.

FIG. 10 is a flowchart illustrating an example of a processing procedure in a method of controlling an image forming apparatus according to a third embodiment.

FIG. 11 is a diagram illustrating an example of a setting display screen displayed on an operation device, to set whether to return a printer engine from a power saving state in a case where the printer engine is in the power saving state according to the third embodiment.

### DESCRIPTION OF THE EMBODIMENTS

Embodiments for implementing the present disclosure will be described below with reference to the attached drawings.

### First Embodiment

A first embodiment will now be described.

### Configuration of Image Forming Apparatus

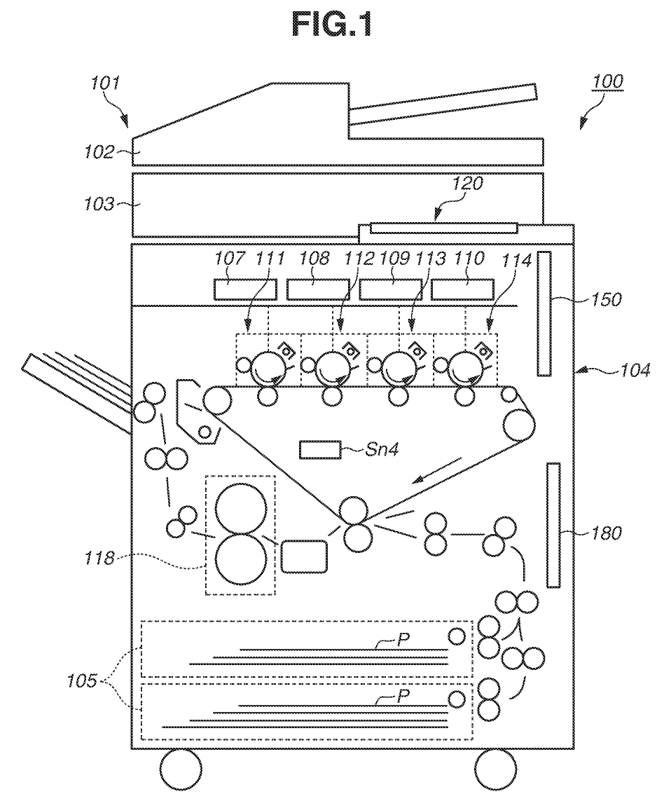

FIG. 1 is a diagram illustrating an example of a schematic configuration of an image forming apparatus 100 according to the first embodiment.

As illustrated in FIG. 1, the image forming apparatus 100 includes an image reading apparatus 101 as an example of an image reading unit, a printer engine 104 as an example of an image forming unit, and an operation device 120. The image forming apparatus 100 illustrated in FIG. 1 is merely illustrative, and for example, a facsimile apparatus, an inkjet printer, or a multifunctional peripheral each including the image reading apparatus 101 are also within the scope of present embodiment.

The image forming apparatus 100 illustrated in FIG. 1 has a configuration in which the image reading apparatus 101 and the operation device 120 are provided above the printer engine 104.

As illustrated in FIG. 1, the image reading apparatus 101 includes an auto document feeder (ADF) 102 as an example of a document conveyance unit that conveys a document, and a reader 103 that reads an image of the document conveyed by the ADF 102.

The printer engine 104 includes sheet feeding cassettes 105 for loading a sheet P as an example of a recording medium on which an image is to be formed by the printer engine 104. The printer engine 104 also includes laser scanners 107, 108, 109, and 110 for yellow, magenta, cyan and black, respectively, as electrophotographic print engines, image forming units 111, 112, 113, and 114, and a fixing unit 118. The printer engine 104 includes a system controller 150, an engine controller 180, and an environment sensor Sn4.

The system controller 150 is connected to each of the units in the image forming apparatus 100, and controls the units to realize, for example, a copy operation, a printing operation, a scan operation, and a facsimile operation. The engine controller 180 is a unit for controlling the printer engine 104 that performs image formation of the above-described electrophotographic method. The environment sensor Sn4 is an environment sensor for detecting environmental information of the surrounding environment, and detects, for example, information on temperature and information on humidity as the environmental information. While in the present embodiment, the environment sensor Sn4 is configured to detect, as the environmental information, information on temperature and information on humidity, the environment sensor Sn4 is not limited to this configuration and may detect, for example, at least one of information on temperature or information on humidity. In the present embodiment, the system controller 150 is an example of an control unit that controls the printer engine 104, which is an example of the image forming unit, and the image reading apparatus 101, which is an example of the image reading unit, and acquires the above-described environmental information from the environment sensor Sn4.

The operation device 120 includes a display screen that receives a job operation instruction from the user and displays the status of the image forming apparatus 100 and information that is to be notified to the user. The operation device 120 is controlled by the system controller 150. The operation device 120 is an example of a setting unit for performing various types of settings, for example, in response to the job operation instruction from the user.

The image forming apparatus 100 according to the present embodiment includes a mode for a normal operation state and a mode for a power saving state (power saving mode) where power supply is interrupted, for each of the printer engine 104 and the image reading apparatus 101. Therefore, the image forming apparatus 100 according to the present embodiment is configured such that, when the printer engine 104 or the image reading apparatus 101 is not operated, the printer engine 104 or the image reading apparatus 101 transitions to the mode for the power saving state (power saving mode) to suppress power consumption. In the present embodiment, even in a case where the printer engine 104 or the image reading apparatus 101 is in the mode for the power saving state (power saving mode), at least the system controller 150 that controls the image forming apparatus 100 is in the mode for the normal operation state where power is supplied.

### Configuration of Image Reading Apparatus

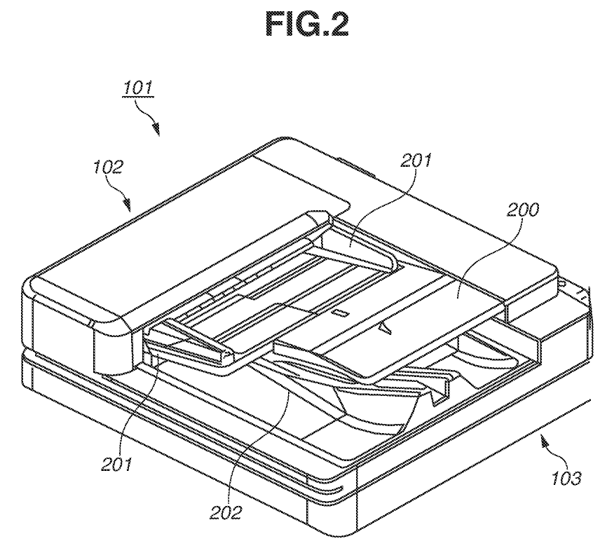

FIG. 2 illustrates an example of the image reading apparatus 101 according to the present embodiment. In FIG. 2, components similar to the components illustrated in FIG. 1 will be denoted by the same reference numerals, and detailed description of the components will be omitted.

The image reading apparatus 101 includes the ADF 102 that conveys a document (document sheet) that is placed by the user on a document tray 200 and between side regulation plates 201, and the reader 103 that reads an image of the document conveyed by the ADF 102. The ADF 102 also includes a discharge tray 202 where the document from which the reader 103 read an image is discharged to.

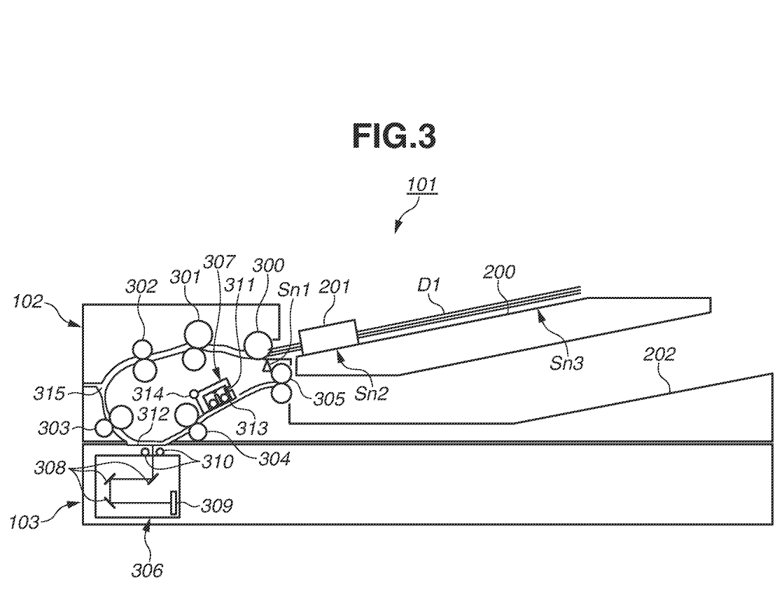

FIG. 3 is a cross-sectional view illustrating an example of an internal configuration of the image reading apparatus 101 according to the present embodiment. In FIG. 3, components similar to the components illustrated in FIGS. 1 and 2 will be denoted by the same reference numerals, and detailed description of the components will be omitted.

As illustrated in FIG. 3, the ADF 102 includes the document tray 200 in its upper part. The user places documents (document sheets) D1 on the document tray 200 and between the side regulation plates 201, and instructs the start of a scan job for the documents D1 using the operation device 120. When the scan job is started, the documents D1 on the document tray 200 are sequentially fed from an uppermost document by a feeding roller 300. The fed documents D1 are separately fed one by one by a separation roller pair 301. Each of the separately fed documents D1 is conveyed by conveyance roller pairs 302, 303, and 304 through a conveyance path 315. At this time, an image on a front surface of each of the documents D1 is read by a first reading unit 306 when each of the documents D1 passes through a document reading glass 312 of the reader 103. More specifically, the first reading unit 306 reads scattered reflected light of light emitted onto the front surface of each of the documents D1 from an illumination 310, and acquires a light image formed on a complementary metal-oxide semiconductor (CMOS) sensor 309 via mirrors 308, as a read image on the front surface of each of the documents D1. An image on a rear surface of each of the documents D1 is read by a second reading unit 307 positioned on a downstream side of the first reading unit 306 in a conveyance direction. The second reading unit 307 includes a rear-surface reading sensor case 314, and a CMOS image sensor (CIS) 311 stored in a glass 313. More specifically, the second reading unit 307 acquires a read image on the rear surface of each of the documents D1 by the CIS 311 when each of the conveyed documents D1 passes through the glass 313. Thereafter, each of the documents D1 from which the image has been read is discharged onto the discharge tray 202 by a discharge roller pair 305.

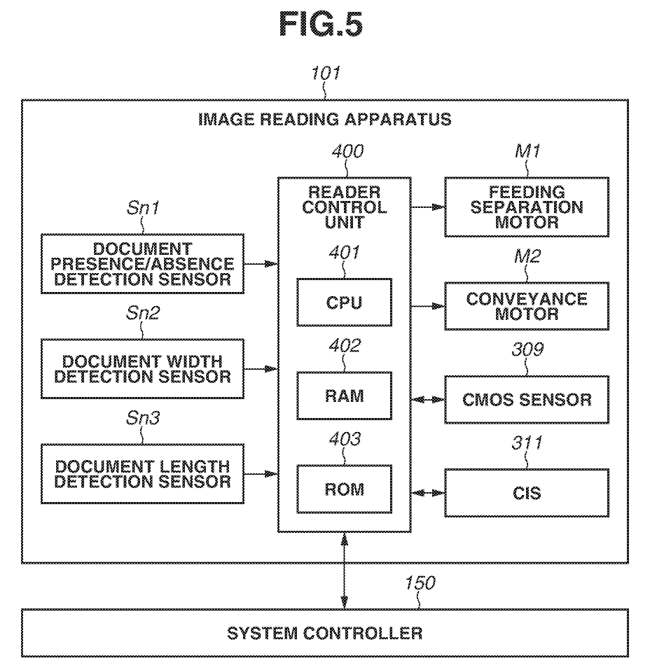

The ADF 102 also includes, as document detection units, a document presence/absence detection sensor Sn1, a document width detection sensor Sn2, and a document length detection sensor Sn3. An optical sensor of a reflection type or a transmission type can be used as the document presence/absence sensor Sn1 and the document length detection sensor Sn3. An optical sensor such as a photo-interrupter that detects the positions of light shielding plates provided in the side regulation plates 201 can be used as the document width detection sensor Sn2. The information (signals) detected by the sensors Sn1 to Sn3 is output to a reader control unit (reader control unit 400 illustrated in FIG. 5) provided in the reader 103, and is determined by the reader control unit.

Based on the above, the sensor sSn1 to Sn3 function as follows. The document presence/absence sensor Sn1 detects the presence/absence of the documents D1 on the document tray 200. The document width detection sensor Sn2 detects a width of the documents D1 on the document tray 200 by detecting positions of the side regulation plates 201 that regulate the width of the documents D1. The document length detection sensor Sn3 detects whether a length of the documents D1 on the document tray 200 is greater than or equal to a predetermined length.

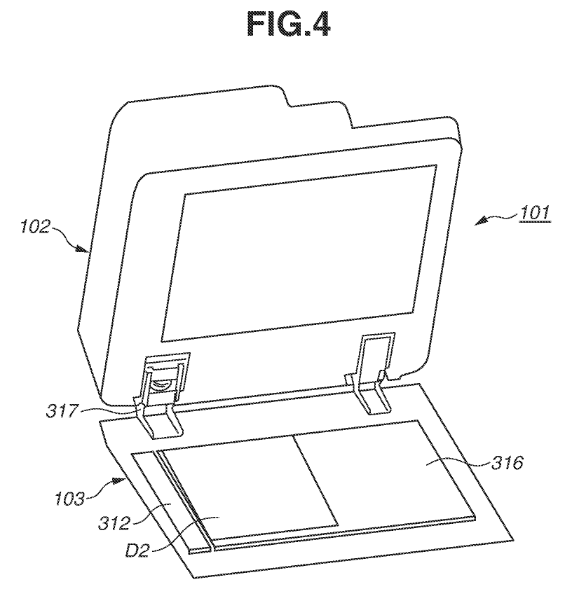

FIG. 4 illustrates examples of the reader 103 and the ADF 102 in a case where the ADF 102 is in an open state relative to the reader 103 in the image reading apparatus 101 according to the present embodiment. In FIG. 4, components similar to the components illustrated in FIGS. 1 to 3 will be denoted by the same reference numerals, and detailed description of the components will be omitted.

As illustrated in FIG. 4, the ADF 102 is supported by hinges 317 to be pivotable relative to the reader 103 such that a document platen glass 316 of the reader 103 can be exposed. When the ADF 102 is opened relative to the reader 103, a document D2 can be placed on the document platen glass 316. When the first reading unit 306 of the reader 103 is moved for scanning, an image of the document D2 placed on the document platen glass 316 can be read.

FIG. 5 is a diagram illustrating an example of a hardware configuration of the image reading apparatus 101 according to the first embodiment. In FIG. 5, components similar to the components illustrated in FIGS. 1 to 4 will be denoted by the same reference numerals, and detailed description of the components will be omitted.

As illustrated in FIG. 5, the image reading apparatus 101 includes the document presence/absence detection sensor Sn1, the document width detection sensor Sn2, the document length detection sensor Sn3, the reader control unit 400, a feeding separation motor M1, a conveyance motor M2, the CMOS sensor 309, and the CIS 311.

The feeding roller 300 and the separation roller pair 301 illustrated in FIG. 3 are electrically connected to and driven by the feeding separation motor M1 illustrated in FIG. 5, which serves as the common driving source for the feeding roller 300 and the separation roller pair 301. The conveyance roller pairs 302, 303, and 304 and the discharge roller pair 305 illustrated in FIG. 3 are electrically connected to and driven by the conveyance motor M2 illustrated in FIG. 5.

The reader control unit 400 is incorporated in the reader 103, and controls the document conveyance by the ADF 102, the reading operation of a document image by the reader 103, and the like. As illustrated in FIG. 5, the reader control unit 400 is electrically connected to the system controller 150 and, in cooperation with the system controller 150, performs a document reading operation as instructed by the user.

As illustrated in FIG. 5, the reader control unit 400 includes a central processing unit (CPU) 401, a random access memory (RAM) 402, and a read only memory (ROM) 403. The CPU 401 controls the operation of the image reading apparatus 101 and performs various types of processing. The RAM 402 is used as a work area when the CPU 401 performs processing while controlling the components of the image reading apparatus 101. The RAM 402 stores various types of information (including data) and the like obtained when the CPU 401 performs various types of control and various types of processing. The ROM 403 stores programs executed by the CPU 401 when performing various types of control and various types of processing, various types of information (including data) used by the CPU 401 when performing various types of control and various types of processing, and the like.

The document presence/absence detection sensor Sn1, the document width detection sensor Sn2, and the document length detection sensor Sn3 described above are electrically connected to the reader control unit 400, and various types of detection information are input to the reader control unit 400 from the sensors Sn1 to Sn3. The feeding separation motor M1 and the conveyance motor M2, which are examples of a driving unit, and the CMOS sensor 309 and the CIS 311, which are examples of an image acquisition unit, are electrically connected to the reader control unit 400.

The reader control unit 400 sets the driving speeds of the above-described driving units based on a target conveyance speed of a document (document sheet), and sets the image acquisition speeds (reading speeds) of the above-described image acquisition units based on the driving speeds. The driving speeds of the driving units and the image acquisition speeds (reading speeds) of the image acquisition units described above are adjustable. The reader control unit 400 also includes functions as a driving speed adjustment unit and an image acquisition speed (reading speed) adjustment unit.

Mode control for setting the driving speeds of the driving units such as the feeding separation motor M1 and the conveyance motor M2 illustrated in FIG. 5 will now be described.

In the present embodiment, in the ADF 102 illustrated in FIG. 3, the document tray 200 and the discharge tray 202 are located at positions overlapping with each other in a vertical direction. Therefore, the conveyance path 315 illustrated in FIG. 3, via which the documents D1 are conveyed, is formed in a U-shape (i.e., a curved shape), as viewed in a width direction orthogonal to a sheet conveyance direction, such that the front and rear surfaces of each of the documents D1 are inverted. In this case, the documents D1 to be conveyed are also conveyed while being curved along the conveyance path 315, and accordingly, conveyance resistance is varied depending on the type of the documents D1 to be conveyed. At this time, the conveyance resistance is increased as the stiffness of the documents D1 (force to return to its original shape when document D1 is bent) is increased.

Depending on the size of the document D1, the area of the document D1 abutting on the conveyance path 315 and the manner in which the document D abuts on the conveyance path 315 change, and therefore, the conveyance speed varies. Depending on the size of the document D1, the number of documents D1 that can be conveyed while being nipped by the plurality of conveyance roller pairs (conveyance roller pairs 302, 303, and 304) varies, and therefore, the conveyance force varies.

The amount of slippage of each of the conveyance roller pairs (conveyance roller pairs 302, 303, and 304) is determined by the above-described conveyance force and conveyance resistance. Therefore, even when the driving units are driven at the same speed, a difference of several percent occurs in the conveyance speeds. The first reading unit 306 and the second reading unit 307 illustrated in FIG. 3 read an image line by line at a fixed interval based on the image acquisition speed (reading speed) set depending on the driving speeds of the driving units, and output combined line images as a read image. Therefore, when the actual conveyance speed of each of the documents D1 varies relative to the set driving speeds of the driving units, the conveyance amount of each of the documents D1 within the fixed interval for reading the image varies, and thus, the acquired read image is expanded or contracted. More specifically, when the conveyance speed of each of the documents D1 is decreased, the read image obtained by the first reading unit 306 or the second reading unit 307 is expanded in a sub-scanning direction, whereas when the conveyance speed of each of the documents D1 is increased, the read image is contacted in the sub-scanning direction. As a result, the quality of the read image is lowered.

The ADF 102 copes with the expansion/contraction of the read image that is caused by the variation in the conveyance speed of each of the documents D1 due to the difference in the stiffness and the size of the documents D1 described above by using the above-described functions of the driving speed adjustment unit and the image acquisition speed (reading speed) adjustment unit.

Even for the documents having the same thickness and the same size, the stiffness and surface properties (i.e., the coefficient of friction) of the document change depending on the usage environment (temperature, humidity, etc.). As a result, the conveyance resistance and the amount of slippage of each of the conveyance roller pairs described above vary, leading to fluctuations in the conveyance speed of the document. For example, in a low-humidity environment (humidity of about 10%), the documents D1 lose moisture, and accordingly, the stiffness of each of the documents D1 is increased, and the frictional force between the conveyance roller and each of the documents D1 is decreased. Therefore, in the above-described low-humidity environment, the amount of slippage of each of the conveyance rollers is increased and the conveyance speed of the documents D1 is decreased compared with a comfortable humidity environment (humidity of about 50% to about 60%). As a result, the read image is expanded in the sub-scanning direction. In a high-humidity environment (humidity of about 80%), the conveyance speed of the documents D1 is increased. As a result, the read image is contracted in the sub-scanning direction. The factors that change the conveyance speed of the documents (document sheets) D1 depending on the usage environment include, in addition to the above-described humidity change, an increase/decrease in the outer diameter of each of the conveyance rollers due to a temperature change. In the present embodiment, it is assumed that, for example, silicon rubber is used as a material for the conveyance rollers, and, for example, when the temperature changes by 10°C, the outer diameter of each of the conveyance rollers is varied by about 0.10% to about 0.15%. The variation in the outer diameter of each of the conveyance rollers directly affects the conveyance speed of the documents D1. Therefore, the conveyance speed of the documents D1 increases as the temperature rises. When two conveyance speed variation factors, which are the influence of the humidity and the influence of the temperature described above, simultaneously occur, the expansion/contraction amount of the read image is further increased. Therefore, in the present embodiment, to ensure the quality (image quality) of the image read by the image reading apparatus 101 under any environment, the document conveyance control and the document image reading control are performed using the environmental information such as the temperature and the humidity.

More specifically, in the present embodiment, the environmental information detected by the environment sensor Sn4 that is provided for temperature adjustment control when the printer engine 104 fixes and forms an image on a sheet P is used. In the present embodiment, the image reading apparatus 101 and the printer engine 104 are not directly electrically connected. Therefore, a configuration is implemented in which the environmental information detected by the environment sensor Sn4 is transmitted via the system controller 150 that controls the image reading apparatus 101 and the printer engine 104.

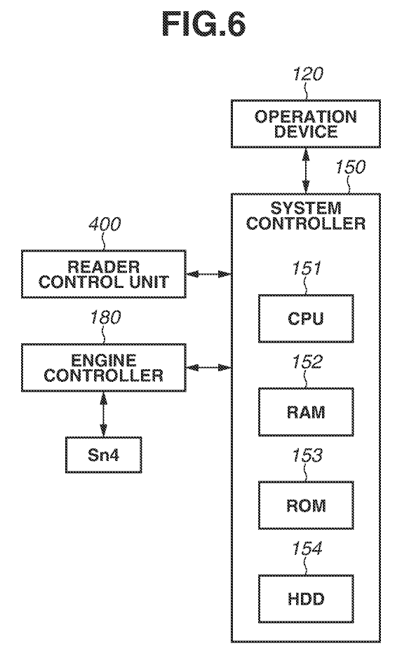

FIG. 6 is a diagram illustrating a configuration example of a control system of the image forming apparatus 100 according to the first embodiment.

In FIG. 6, components similar to the components illustrated in FIGS. 1 to 5 will be denoted by the same reference numerals, and detailed description of the components will be omitted.

As illustrated in FIG. 6, the system controller 150 includes a CPU 151, a RAM 152, a ROM 153, and a hard disk drive (HDD) 154. The CPU 151 controls the operation of the image forming apparatus 100, and also performs various types of processing. The RAM 152 is used as a work area when the CPU 151 performs processing while controlling the components of the image forming apparatus 100. The RAM 152 stores various types of information (including data) and the like obtained when the CPU 151 performs various types of control and various types of processing. The ROM 153 stores programs executed by the CPU 151 for performing various types of control and various types of processing, various types of information (including data) used by the CPU 151 for performing various types of control and various types of processing, and the like. The HDD 154 stores various types of information (including data) used by the CPU 151 for performing various types of control and various types of processing, and stores various types of information (including data) obtained when the CPU 151 performs various types of control and various types of processing.

As illustrated in FIG. 6, the system controller 150 is communicably connected (electrically connected) to the reader control unit 400 of the image reading apparatus 101, an engine controller 180 of the printer engine 104, and the operation device 120. The environment sensor Sn4 provided in the printer engine 104 is electrically connected to the engine controller 180. Therefore, the engine controller 180 can obtain numerical values of the environmental information such as the temperature and the humidity from the environment sensor Sn4.

In a case where acquisition of the environmental information is requested from the system controller 150, the engine controller 180 acquires the environmental information from the environment sensor Sn4, and notifies the system controller 150 of the environmental information. In addition, the system controller 150 notifies the reader control unit 400 of the environmental information as necessary.

In the present embodiment, at a predetermined timing when the image forming apparatus 100 is turned on, at a predetermined timing when the image forming apparatus 100 returns from the power saving state to the normal operation state, or at a predetermined timing when the job operation ends, the environmental information is provided from the engine controller 180 to the system controller 150. The system controller 150, after acquiring the environmental information from the engine controller 180, overwrites the HDD 154 with the acquired environmental information each time, and then stores the updated environmental information.

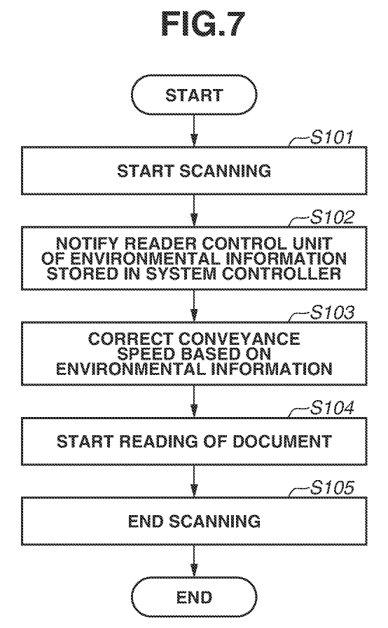

FIG. 7 is a flowchart illustrating an example of a processing procedure in a method of controlling the image forming apparatus 100 according to the present embodiment. In the flowchart illustrated in FIG. 7, in a scan job operation, the conveyance of the document by the ADF 102 is controlled based on the environmental information acquired by the system controller 150 when the image reading apparatus 101 starts reading of a document image.

In step S101, when the user sets a document on the ADF 102 and performs an operation to start a scan job using the operation device 120, the system controller 150 detects the operation. The system controller 150 then controls the reader control unit 400 of the image reading apparatus 101 and the engine controller 180 of the printer engine 104. For example, the reader control unit 400 detects the documents D1 on the document tray 200 using the document presence/absence sensor Sn1, and determines the size of the documents D1 based on a detection result of the document width detection sensor Sn2 and a detection result of the document length detection sensor Sn3. In the present embodiment, a predetermined initial conveyance speed is set irrespective of the size of the documents D1. The initial conveyance speed may be set for each size of the documents D1 based on the features of the image reading apparatus 101. Thereafter, the reader control unit 400 sets a driving speed of each of the driving motors (feeding separation motor M1 and conveyance motor M2). As a result, each of the rollers (feeding roller 300, separation roller pair 301, conveyance roller pairs 302, 303, and 304, and discharge roller pair 305) of the ADF 102 is rotationally driven at the set driving speed, and the conveyance speed of the documents D1 is determined.

In step S102, the system controller 150 reads out the environmental information stored in the HDD 154 and notifies the reader control unit 400 of the image reading apparatus 101 of the environmental information while instructing the reader control unit 400 to start the scan job. The environmental information according to the present embodiment is information acquired at least at one of the following predetermined timings: the timing when the image forming apparatus 100 is turned on; the timing when the image forming apparatus 100 returns from the power saving state to the normal operation state; or the timing when the job operation ends.

In step S103, the reader control unit 400 performs document conveyance control to, based on the environmental information notified from the system controller 150 in step S102, control the conveyance of the document by the ADF 102. More specifically, the reader control unit 400 controls (corrects), based on the environmental information notified in step S102, the document conveyance speed for the ADF 102 to convey the document.

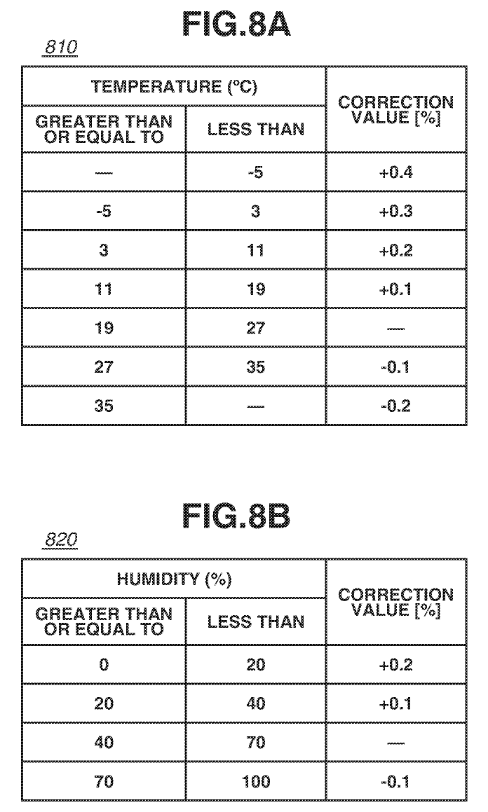

FIGS. 8A and 8B illustrate processing for correcting the document conveyance speed in step S103 of FIG. 7. More specifically, FIG. 8A illustrates a conveyance speed correction table 810 based on the temperature information, and FIG. 8B illustrates a conveyance speed correction table 820 based on the humidity information. The conveyance speed correction table 810 based on the temperature information illustrated in FIG. 8A and the conveyance speed correction table 820 based on the humidity information illustrated in FIG. 8B are stored in, for example, the ROM 403 of the reader control unit 400.

When the reader control unit 400 acquires the temperature information as the environmental information, the reader control unit 400 sets, based on the conveyance speed correction table 810 based on the temperature information illustrated in FIG. 8A, an acceleration percentage or a deceleration percentage as a correction value for the initial conveyance speed set in step S101. In the present embodiment, a range from 19°C to 27°C is assumed to be a normal temperature environment in the conveyance speed correction table 810 based on the temperature information illustrated in FIG. 8A. In a case of a temperature higher than the temperature range, the reader control unit 400 performs correction to reduce the conveyance speed. In a case of a temperature lower than the temperature range, the reader control unit 400 performs correction to increase the conveyance speed.

The conveyance speed correction table 810 based on the temperature information illustrated in FIG. 8A is set based on values by which the outer diameter of the roller used in the present embodiment varies due to temperature changes. Therefore, the values illustrated in FIG. 8A are to be appropriately and individually set depending on the embodiment.

When the reader control unit 400 acquires the humidity information as the environmental information, the reader control unit 400 sets, based on the conveyance speed correction table 820 based on the humidity information illustrated in FIG. 8B,. In the present embodiment, a range from 40% to 70% is assumed to be a normal humidity environment in the conveyance speed correction table 820 based on the humidity information illustrated in FIG. 8B. In a case of a humidity higher than the humidity range, the reader control unit 400 performs correction to reduce the conveyance speed. In a case of a humidity lower than the humidity range, the reader control unit 400 performs correction to increase the conveyance speed. The values illustrated in FIG. 8B are to be appropriately and individually set depending on the embodiment.

In the conveyance speed correction tables 810 and 820 illustrated in FIGS. 8A and 8B, predetermined correction values (%) are applied irrespective of the documents D1 to be conveyed. The tables may have different correction values depending on the size of the documents D1. In the present embodiment, the correction values are set using the different conveyance speed correction tables based on the temperature information and the humidity information. The correction values may be set based on combinations of the temperature information and the humidity information. For example, in a case where the temperature is less than or equal to 15°C and the humidity is less than or equal to 10%, +0.4% or the like may be set as the correction value (%) for the conveyance speed.

Returning to FIG. 7, when the processing in step S103 of FIG. 7 ends, the processing proceeds to step S104.

In step S104 of FIG. 7, the reader control unit 400 sets corrected conveyance speed (corrected driving speed) based on the environmental information to each of the driving motors (feeding separation motor M1 and conveyance motor M2), and each of the conveyance roller pairs conveys the documents D1 at the set conveyance speed. As a result, the document image reading processing by the image reading apparatus 101 is started to be performed. This processing enables the image of each of the documents D1 to be read at an optimum conveyance speed irrespective of the type of the documents D1 and the usage environment. This makes it possible to secure the quality (image quality) of the read image.

In step S105 of FIG. 7, when reading of the images of all documents D1 set in the ADF 102 is completed, the reader control unit 400 ends the scan job. When the processing in step S105 of FIG. 7 ends, the processing in the flowchart of FIG. 7 ends.

The image forming apparatus 100 according to the first embodiment described above includes the following configuration.

The image forming apparatus 100 includes the printer engine 104 that serves as the image forming unit including the environment sensor Sn4 for detecting the environmental information. The image forming apparatus 100 also includes the image reading apparatus 101 that serves as the image reading unit for reading an image of the document, where the image reading apparatus 101 includes the ADF 102 that serves as the document conveyance unit for conveying the document.

The image forming apparatus 100 includes the system controller 150 that serves as the integration control unit for controlling the printer engine 104 and the image reading apparatus 101 and acquiring the environmental information from the environment sensor Sn4 provided in the printer engine 104. For example, even in a case where the printer engine 104 is in the mode for the power saving state (power saving mode), the system controller 150 operates in the mode for the normal operation state where the power is supplied. The image forming apparatus 100 includes the reader control unit 400 that serves as the conveyance control unit for performing the document conveyance control to control the conveyance of the document by the ADF 102 based on the environmental information acquired by the system controller 150 when the image reading apparatus 101 starts reading of the document image.

According to the above-described configuration, irrespective of whether the printer engine 104 that includes the environment sensor Sn4 for detecting the environmental information is in the power saving state, the document conveyance control can be performed by the image reading apparatus 101 based on the environmental information.

### Second Embodiment

A second embodiment will now be described. In the following description of the second embodiment, descriptions of matters common to the above-described first embodiment will be omitted.

The configuration of an image forming apparatus according to the second embodiment is similar to the configuration of the image forming apparatus 100 according to the first embodiment as illustrated in FIG. 1. The configuration of an image reading apparatus according to the second embodiment is similar to the configuration of the image reading apparatus 101 according to the first embodiment as illustrated in FIGS. 2 to 5.

In the above-described first embodiment, the system controller 150 acquires the environmental information detected by the environment sensor Sn4 from the reader control unit 400 at the above-described predetermined timing. Therefore, according to the first embodiment, the environmental information acquired by the system controller 150 may be environmental information on a past usage environment. In this case, when the past usage environment is different from the current usage environment, the accuracy of the environmental information is lowered, and the optimum document conveyance control may not be performed. The second embodiment addresses this situation.

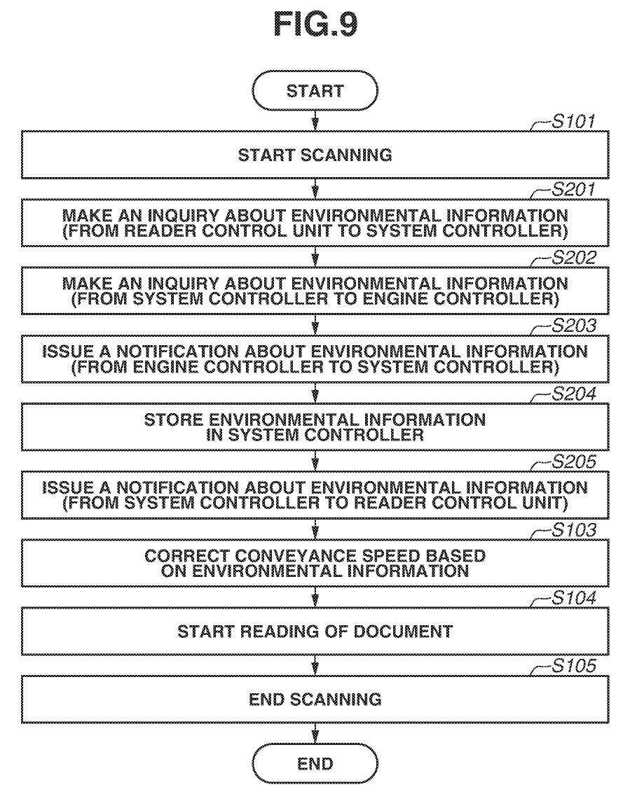

FIG. 9 is a flowchart illustrating an example of a processing procedure in a method of controlling the image forming apparatus 100 according to the second embodiment. In the flowchart of FIG. 9, processing steps similar to the processing steps in the flowchart of FIG. 7 will be denoted by the same step numbers, and the detailed description of these processing steps will be omitted.

In step S101 of FIG. 9, processing similar to the processing in step S101 of FIG. 7 is performed, and a scan job is started.

In step S201, the reader control unit 400 inquires with the system controller 150 about acquisition of the environmental information.

In step S202, the system controller 150 inquires with the engine controller 180 about acquisition request of the environmental information.

In step S203, the engine controller 180 acquires the current environmental information from the environment sensor Sn4, and notifies the system controller 150 of the acquired environmental information.

In step S204, the system controller 150 acquires the current environmental information from the engine controller 180 via the processing in step S203, and stores the acquired environmental information as the latest environmental information in the HDD 154.

In step S205, the system controller 150 notifies the reader control unit 400 of the environmental information acquired and stored in step S204.

Step S103 of FIG. 9 is similar to step S103 of FIG. 7, where the reader control unit 400 performs the document conveyance control to control the conveyance of the document by the ADF 102 based on the environmental information provided from the system controller 150. More specifically, the reader control unit 400 controls (corrects), based on the environmental information notified in step S205, the document conveyance speed for the ADF 102 to convey the document.

The processing similar to that in steps S104 and S105 of FIG. 7 is then performed. The processing in the flowchart of FIG. 9 then ends.

In the image forming apparatus 100 according to the present embodiment, the system controller 150, which serves as the system control unit, acquires the environmental information from the environment sensor Sn4 when the image reading apparatus 101 starts reading of an image of a document. The reader control unit 400, which serves as the conveyance control unit, performs, based on the environmental information acquired by the system controller 150 when the image reading apparatus 101 starts the reading of the image of the document, the document conveyance control to control the conveyance of the document by the ADF 102.

According to the above-described configuration, since the environmental information at a time point when the image reading apparatus 101 starts the reading of the image of the document can be reflected on the document conveyance control to control the conveyance of the document by the ADF 102, it is possible to perform optimum document conveyance control.

### (Third Embodiment)

A third embodiment will be now described. In the description of the third embodiment, descriptions of matters common to the above-described first and second embodiments will be omitted.

The configuration of an image forming apparatus according to the third embodiment is similar to the configuration of the image forming apparatus 100 according to the first embodiment as illustrated in FIG. 1. In addition, the configuration of an image reading apparatus according to the third embodiment is similar to the configuration of the image reading apparatus 101 according to the first embodiment as illustrated in FIGS. 2 to 5.

In the above-described second embodiment, in a case where the printer engine 104 including the environment sensor Sn4 is in the mode for the power saving state (power saving mode), the environmental information is not provided from the engine controller 180 to the system controller 150 under these circumstances. Therefore, in the case where the printer engine 104 is in the mode of for power saving state, the notification about the environmental information may be provided from the engine controller 180 to the system controller 150 after the printer engine 104 returns from the power saving state to the normal operation state. In a case where the processing that the user desires for the image forming apparatus 100 is only the processing for reading the document image and the user does not desire a printing operation to be performed by the printer engine 104, the printer engine 104 returns from the power saving state only to acquire the environmental information. Therefore, for the user who wants to prioritize reduction in the power consumption by power saving and suppression in the operation sounds of the printer engine 104, it may be desirable that the image forming apparatus 100 is operated without returning the printer engine 104 from the power saving state to the normal operation state. Some users may want to prioritize the quality (image quality) of the image read from the document, which can be realized by performing document conveyance control based on the current environmental information. The third embodiment, to achieve both of the above-described user desires, provides a setting for switching whether to return the printer engine 104 from the power saving state to the normal operation state based on the demand of the user at the acquisition of the environmental information.

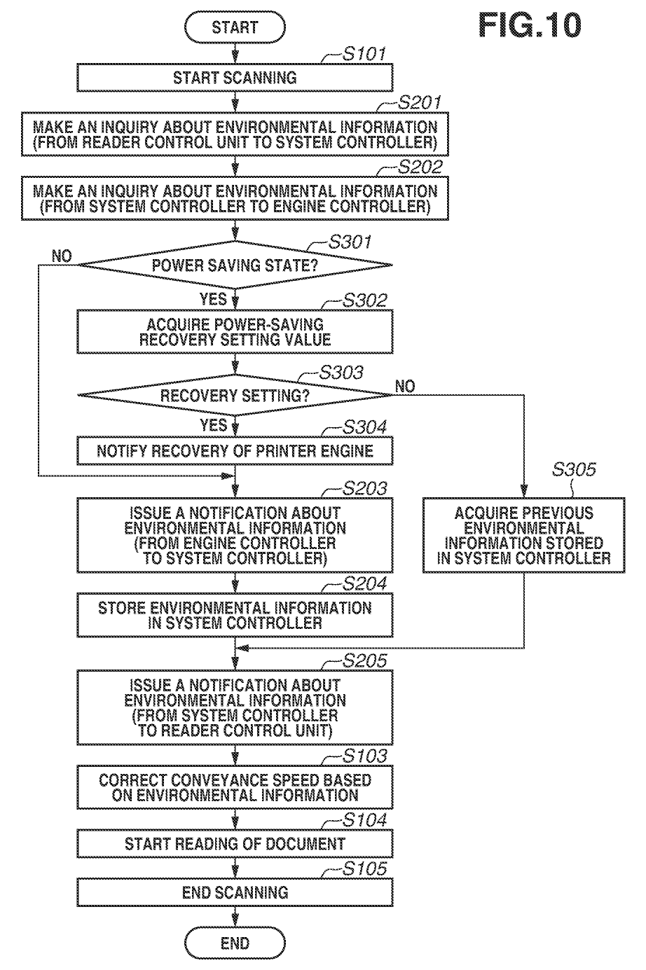

FIG. 10 is a flowchart illustrating an example of a processing procedure in a method of controlling the image forming apparatus 100 according to the third embodiment. In the flowchart illustrated in FIG. 10, processing steps similar to the processing steps in the flowchart illustrated in FIGS. 7 and 9 will be denoted by the same step numbers, and the detailed description of the processing steps will be omitted.

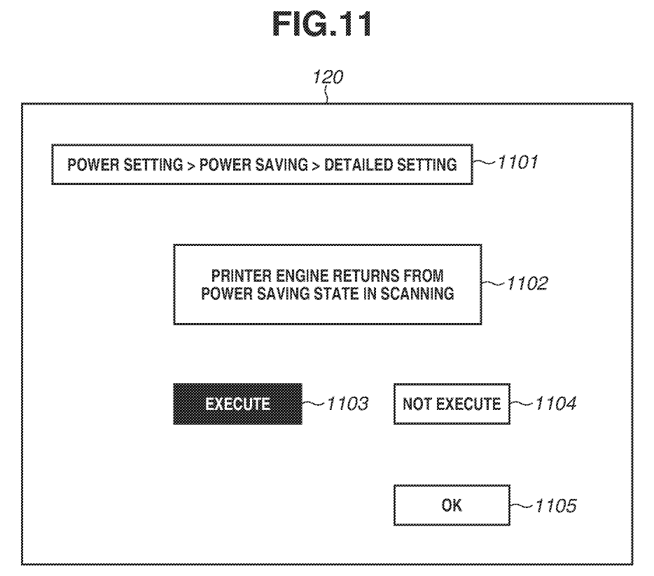

FIG. 11 is a diagram illustrating an example of a setting display screen displayed on the operation device 120 to set whether to return the printer engine 104 from the power saving state in the case where the printer engine 104 is in the power saving state. The setting display screen illustrated in FIG. 11 includes setting content display areas 1101 and 1102, an "execute" button 1103, a "not execute" button 1104, and an "OK" button 1105. In the setting content display area 1102, the setting content indicating whether to return the printer engine 104 in the power saving state from the power saving state to the normal operation state at the acquisition of the environmental information in scanning (at the start of a scan job) is displayed. In a case where the "OK" button 1105 is operated in a state where the "execute" button 1103 is selected, a first setting value for returning the printer engine 104 in the power saving state from the power saving state to the normal operation state at the acquisition of the environmental information in scanning is set. In a case where the first setting value is set, the system controller 150 returns the printer engine 104 from the power saving state to the normal operation state at the start of the scan job, and acquires the environmental information at that time point from the environment sensor Sn4 via the engine controller 180.

In a case where the "OK" button 1150 is operated in a state where the "not execute" button 1104 is selected, a second setting value for not returning the printer engine 104 in the power saving state from the power saving state to the normal operation state at the acquisition of the environmental information in scanning is set. In a case where the second setting value is set, the system controller 150 does not return the printer engine 104 from the power saving state to the normal operation state at the start of the scan job, and acquires the environmental information acquired at the above-described predetermined timing and stored in the HDD 154. The setting display screen illustrated in FIG. 11 illustrates a state where the "execute" button 1103 is selected and inversely displayed. The setting using the setting display screen illustrated in FIG. 11 is performed before the start of the processing in the flowchart illustrated in FIG. 10, and the above-described first setting value and second setting value are stored as power-saving recovery setting values in, for example, the HDD 154 of the system controller 150.

The processing of the flowchart in FIG. 10 will now be described. In step S101 of FIG. 10, processing similar to the processing in step S101 of FIG. 7 is performed, and a scan job is started.

In step S201, processing similar to the processing in step S201 of FIG. 9 is performed, and the reader control unit 400 inquires with the system controller 150 regarding the acquisition of the environmental information. In step S202, processing similar to the processing in step S202 of FIG. 9 is performed, and the system controller 150 inquires with the engine controller 180 regarding the acquisition request of the environmental information.

In step S301, the system controller 150 determines whether the printer engine 104 is in the power saving state based on, for example, a result of the inquiry in step S202.

In step S301, in a case where the system controller 150 determines that the printer engine 104 is in the power saving state (YES in step S301), the processing proceeds to step S302.

In step S302, the system controller 150 reads out and acquires the power-saving recovery setting value stored in the HDD 154.

In step S303, the system controller 150 determines whether to return the printer engine 104 in the power saving state from the power saving state to the normal operation state based on the power-saving recovery setting value acquired in step S302. In step S303, in a case where the power-saving recovery setting value is the above-described first setting value, it is determined to return the printer engine 104 in the power saving state from the power saving state to the normal operation state (YES in step S303).

In step S303, in a case where the power-saving recovery setting value is the above-described second setting value, it is determined not to return the printer engine 104 in the power saving state from the power saving state to the normal operation state (NO in step S303).

In step S303, in a case where the system controller 150 determines to return the printer engine 104 in the power saving state from the power saving state to the normal operation state (YES in step S303), the processing proceeds to step S304.

In step S304, the system controller 150 notifies the engine controller 180 of a recovery request of the printer engine 104. As a result, the printer engine 104 returns from the power saving state to the normal operation state.

After the processing in step S304 ends, the processing proceeds to step S203. In step S301, in a case where the system controller 150 determines that the printer engine 104 is not in the power saving state (i.e., the printer engine 104 is in the normal operation state) (NO in step S301), the processing proceeds to step S203.

In step S203, the engine controller 180 acquires the current environmental information from the environment sensor Sn4, and notifies the system controller 150 of the acquired environmental information. Processing in and after step S203 is similar to the processing in and after step S203 in FIG. 9. Thus, the description of the processing of FIG. 10 following steps S203 will be omitted.

In step S303, in a case where the system controller 150 determines not to return the printer engine 104 in the power saving state from the power saving state to the normal operation state (NO in step S303), the processing proceeds to step S305.

In step S305, the system controller 150 acquires the environmental information stored in the HDD 154 without notifying of the recovery request of the printer engine 104. The processing then proceeds to step S205. Processing in and after step S205 of FIG. 10 is similar to the processing in and after step S205 in FIG. 9. Thus, the description of the processing of FIG. 10 after step S205 will be omitted.

The image forming apparatus 100 according to the present embodiment includes the operation device 120, which serves as the setting unit for setting whether to return the printer engine 104 from the power saving state to the normal operation state in the case where the printer engine 104 is in the power saving state. The system controller 150 controls, based on the setting made via the operation device 120, whether to return the printer engine 104 in the power saving state to the normal operation state in the case where the printer engine 104 is in the power saving state when the image reading apparatus 101 starts the reading of the document image.

According to the above-described configuration, it is possible to switch whether to return the printer engine 104 from the power saving state to the normal operation state upon acquisition of the environmental information based on user demand.

### (Other Embodiments)

In the above-described embodiments of the present disclosure, the document conveyance speed is adjusted based on the size of the document to be conveyed and the temperature and the humidity of the usage environment detected by the respective sensors, where this information may be used in various combinations. In the above-described embodiments of the present disclosure, expansion/contraction of the read image of the document is prevented by adjusting the document conveyance speed. This expansion/contraction may be prevented by adjusting a speed for reading the image from the document.

The above-described embodiments of the present disclosure are merely examples for implementing the present disclosure, and the technical scope of the present disclosure should not be interpreted in a limited manner based on the above-described embodiments. In other words, the present disclosure can be implemented in various forms without departing from the technical idea or the main features of the present disclosure.

According to the present disclosure, it is possible to enable an image reading unit to perform document conveyance control based on environmental information irrespective of whether an image forming unit that includes an environment sensor for detecting the environmental information is in a power saving state.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-165468, filed September 24, 2024, which is hereby incorporated by reference herein in its entirety.

What is claimed is:

1. An image forming apparatus, comprising:
an image forming unit including an environment sensor configured to detect environmental information;
an image reading unit configured to read an image of a document conveyed by a document conveyance unit;
at least one memory storing a program; and
at least one processor, that when executing the program is caused to:
acquire the environmental information from the environment sensor, and
control conveyance of the document based on the acquired environmental information.

2. The image forming apparatus according to claim 1, wherein the at least one processor is further caused to:
acquire the environmental information at a predetermined timing; and
control the conveyance based on the environmental information acquired at the predetermined timing.

3. The image forming apparatus according to claim 2, wherein the predetermined timing is at least one of a timing when the image forming apparatus is turned on, a timing when the image forming apparatus returns from a power saving state to a normal operation state, or a timing when a job operation ends.

4. The image forming apparatus according to claim 1, wherein the at least one processor is further caused to:
acquire the environmental information when the image reading unit starts reading the image of the document; and
control the conveyance based on the environmental information acquired when the image reading unit starts reading the image of the document.

5. The image forming apparatus according to claim 1, wherein, the at least one processor is further caused to, in a case where the image forming unit is in a power saving state when the image reading unit starts reading the image of the document,
return the image forming unit from the power saving state to a normal operation state,
acquire the environmental, and
control the conveyance based on the environmental information acquired when the image forming unit is returned from the power saving state to the normal operation state.

6. The image forming apparatus according to claim 5, wherein the at least one processor is further caused to:
set, in a case where the image forming unit is in the power saving state, whether to return the image forming unit from the power saving state to the normal operation state; and
control based on the setting, in a case where the image forming unit is in the power saving state when the image reading unit starts reading the image of the document, whether to return the image forming unit from the power saving state to the normal operation state.

7. The image forming apparatus according to claim 1, wherein the at least one processor is further caused to:
acquire the environmental information when the image forming unit is not in a power saving state, and not return the image forming unit from the power saving state to a normal operation state in a case where the image forming unit is in the power saving state when the image reading unit starts reading the image of the document; and
control the conveyance based on the environmental information acquired when the image forming unit is in the normal operation state.

8. The image forming apparatus according to claim 1, wherein the at least one processor is further caused to control a conveyance speed of the document.

9. The image forming apparatus according to claim 1, wherein the environment sensor detects, as the environmental information, at least one of temperature information or humidity information.

10. A method of controlling an image forming apparatus including an image forming unit including an environment sensor that detects environmental information and an image reading unit that that reads an image of a document conveyed by a document conveyance unit, the method comprising:
acquiring the environmental information from the environment sensor; and
controlling conveyance of the document based on the acquired environmental information.

11. A non-transitory computer-readable storage medium storing a program for causing a computer to perform a method of controlling an image forming apparatus including an image forming unit including an environment sensor that detects environmental information and an image reading unit that reads an image of a document conveyed by a document conveyance unit, the method comprising:
acquiring the environmental information from the environment sensor; and
controlling conveyance of the document based on the acquired environmental information.
